(19) United States
(12) Patent Application Publication
(10) Pub. No.: US 2005/0087332 A1
(43) Pub. Date: Apr. 28, 2005

(54) Air-conditioning system for motor vehicle

(76) Inventors: Tadashi Umeo, Nagoya-city (JP); Yukio Ueno, Toyokawa-city (JP); Shigenori Hirao, Toyohashi-city (JP)

Correspondence Address: HARNESS, DICKEY & PIERCE, P.L.C., P.O. BOX 828, BLOOMFIELD HILLS, MI, 48303, US

(21) Appl. No.: 10/972,865

(22) Filed: Oct. 22, 2004

(30) Foreign Application Priority Data
Oct. 22, 2003 (JP) 2003-362448

(51) Int. Cl. B60H 3/00; B61D 27/00; B60H 1/00; B60H 1/32

(52) U.S. Cl. 165/202; 165/42; 62/244

(57) ABSTRACT

An air-conditioning system for a truck comprises an air-conditioning unit mounted on a vehicle roof, which has an evaporator and other components for constituting a refrigerating cycle to control temperature of air and to supply the conditioned air into a passenger compartment through multiple blower ducts. The vehicle roof is provided with multiple roof openings, through which the air-conditioning unit and the multiple blower ducts are connected. Each of the blower ducts has an air inlet opening at its upstream side and blower openings at its downstream side, and at least two of the air inlet openings are arranged to close to each other so that a bifurcated connecting element connects the two blower ducts to the unit case through one roof opening. Further, multiple blower openings for different operational modes, such as a face blower opening and a nap-taking blower opening, are formed in a common blower duct, to reduce the number of blower ducts and thereby the number of the roof openings.

### CROSS REFERENCE TO RELATED APPLICATION

This application is based on Japanese Patent Application No. 2003-362448 filed on Oct. 22, 2003, the disclosure of which is incorporated herein by reference.

### FIELD OF THE INVENTION

This invention relates to an air-conditioning system for a motor vehicle, such as a truck, and more particularly to a blower duct device connecting an air-conditioning unit mounted on a vehicle roof with multiple blower openings provided in a passenger compartment for sending conditioned air, temperature and humidity of which is controlled by the air-conditioning unit, to the respective blower openings.

### BACKGROUND OF THE INVENTION

As one of conventional air-conditioning system for a motor vehicle (truck) having an air-conditioning unit on a vehicle roof, such an air-conditioning system as disclosed in U.S. Pat. No. 4,608,834, is known. In this conventional system, an evaporator and a blower for forming a refrigerating cycle are arranged in an air-conditioning unit, an air suction opening for sucking in air from a passenger compartment as well as a blower opening for blowing out cooled air by the evaporator are formed at a bottom portion of the air-conditioning unit, and the bottom portion is inserted into a roof opening formed at the vehicle roof. According to such structure, the air suction opening as well as the blower opening are arranged at a ceiling of the passenger compartment, and the cooled air is blown out from the blower opening arranged above a passenger's head towards an upper body of the passenger. In this conventional system, heating operation and dehumidifying operation can be performed in addition to the above cooling operation.

According to the above conventional system, the blower opening and a blower duct for sending conditioned air to the blower opening can be integrally formed in the air-conditioning unit, and the air-conditioning unit can be easily mounted on the vehicle roof by inserting the bottom portion of the air-conditioning unit into the single unit opening formed at the vehicle roof. For the air-conditioning system for a motor vehicle, multiple operational modes are required, such as a defrosting mode for a front and a side windshields in addition to the cooling mode, heating mode and dehumidifying mode.

For example, if the blower opening is formed at the ceiling of the passenger compartment, a comfortable heating operation to the passenger would be deteriorated because temperature of heated air becomes lower due to a long distance from the blower opening to passenger's feet. Furthermore, in the case of defrosting mode, a sufficient performance can not be obtained, unless the blower opening is provided closer to the windshields. To overcome the above problems, multiple blower openings corresponding to the respective operational modes shall be provided at their appropriate positions in the passenger compartment, and multiple blower ducts shall be necessary for sending conditioned air from an air-conditioning unit mounted on a vehicle roof to the respective blower openings.

In such a system, however, multiple duct openings must be provided at the air-conditioning unit, and connecting portions for the multiple blower ducts and the multiple duct openings are inevitably provided at the roof opening formed at the vehicle roof. Consequently, it would be necessary to form a larger roof opening at the vehicle roof or to form multiple roof openings at the vehicle roof corresponding to the number of the blower ducts. In the case that an evaporator, a blower and other components constituting a refrigerating cycle are arranged in the air-conditioning unit, the weight of the air-conditioning unit becomes larger. When the air-conditioning unit of larger weight is mounted to the vehicle roof having the larger roof opening, reinforcing elements would become necessary to increase mechanical strength of the roof opening. As above, the air-conditioning unit is hardly mounted on the vehicle roof, when the air-conditioning unit has multiple duct openings.

### SUMMARY OF THE INVENTION

The present invention is made in view of the above problems, and it is an object of the present invention to provide an air-conditioning system for a motor vehicle, in particular for a truck in which an air-conditioning unit is mounted on a vehicle roof, which achieves a comfortable air-conditioning performance, by reducing number of connecting portions between an air-conditioning unit and blower ducts and thereby reducing number of roof openings to be formed at the vehicle roof.

According to a feature of the present invention, an air-conditioning unit is mounted on a vehicle roof, in which an evaporator and other components for air-conditioning operation (cooling and heating operations) are assembled. Multiple blower ducts are provided in a passenger compartment, each having an air inlet opening at its upstream side and a blower opening at its downstream side, wherein multiple duct portions are provided at an inner wall of the passenger compartment. Multiple roof openings are formed at the vehicle roof, through which the air inlet openings are connected to an air mixing chamber formed in the air-conditioning unit by means of multiple connecting elements, so that the conditioned air (the temperature of which is controlled at the air-conditioning unit) is blown into the passenger compartment through the multiple blower openings depending on the respective operational modes.

Multiple blower openings for different operational modes, for example, a face blower opening and a nap-taking blower opening, are formed in a common blower duct, to reduce the number of blower ducts. Further, at least two of the air inlet openings of the blower ducts are arranged close to each other, and those air inlet openings are connected to the air mixing chamber through a bifurcated connecting element, which is provided at one roof opening. Accordingly, the number of roof openings to be formed at the vehicle roof can be further reduced.

For example, a defroster blower duct and a foot blower duct are connected to the air mixing chamber by the bifurcated connecting element through one roof opening, while a face blower duct having face blower opening and a nap-taking blower opening and a side defroster blower duct are likewise connected to the air mixing chamber by another bifurcated element through another roof opening, so that the number blower ducts is reduced from five to four and the number of roof openings is reduced from five to two, compared with an air-conditioning system in which five different blower ducts are independently and separately connected to the air mixing chamber through the respective roof openings.

According to another feature of the present invention, the bifurcated connecting element has a pair of air sending openings opening to the air mixing chamber, and a pair of control valves respectively provided at the air sending openings to open or close the air sending openings depending on the respective operational modes.

According to a further feature of the present invention, an electrically driven compressor is assembled to the air-conditioning unit and electrical power is supplied to the compressor from a battery mounted on the motor vehicle or from an outside commercial power source, so that the air-conditioning operation can be continuously carried on even during an engine for the motor vehicle is stopped.

According to a further feature of the present invention, the air-conditioning system comprises a heat pump cycle, in which a flow direction of the refrigerant is changed over depending on the operational modes of a cooling mode and a heating mode, and a part of the compressed refrigerant of high temperature is supplied to a heat exchanger provided at a downstream side of the evaporator to heat the air cooled by the evaporator. Accordingly, it is not necessary to provide a heater core, to which a hot engine cooling water is supplied, for the purpose of heating the air, and thereby any pipe connection between an engine compartment and the air-conditioning unit.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view of an air-conditioning system for a motor vehicle according to a first embodiment of the present invention;

FIG. 2 is a schematic top view of an air-conditioning unit of the air-conditioning system shown in FIG. 1, wherein the air-conditioning unit is mounted on a vehicle roof;

FIG. 3A is a schematic perspective view of a bifurcated connecting element;

FIG. 3B is a cross sectional view of the bifurcated connecting element shown in FIG. 3A, wherein the bifurcated connecting element is assembled to a unit case for the air-conditioning unit;

FIG. 4 is a schematic view of a refrigerating cycle according to the first embodiment;

FIG. 5 is a schematic perspective view of a defroster blower duct and a foot blower duct according to the first embodiment;

FIG. 6 is a schematic perspective view of a side defroster blower duct and a face blower duct according to the first embodiment;

FIG. 7 is a schematic perspective view of a defroster blower duct and a foot blower duct according to a second embodiment of the present invention;

FIG. 8 is a schematic top view of an air-conditioning unit of the air-conditioning system shown in FIG. 7, wherein the air-conditioning unit is mounted on a vehicle roof;

FIG. 9 is a schematic perspective view of a nap-taking blower duct and a side defroster blower duct according to a third embodiment of the present invention;

FIG. 10 is a schematic perspective view of a nap-taking blower duct and a face blower duct according to a modification of the third embodiment;

FIG. 11 is a schematic perspective view of a side defroster blower duct according to a fourth embodiment of the present invention;

FIG. 12 is a schematic perspective view of a face blower duct according to a modification of the fourth embodiment; and

FIG. 13 is a schematic view of a refrigerating cycle according to a further embodiment.

### DETAILED DESCRIPTION OF THE PREFERRED EMBODIMENTS

### First Embodiment

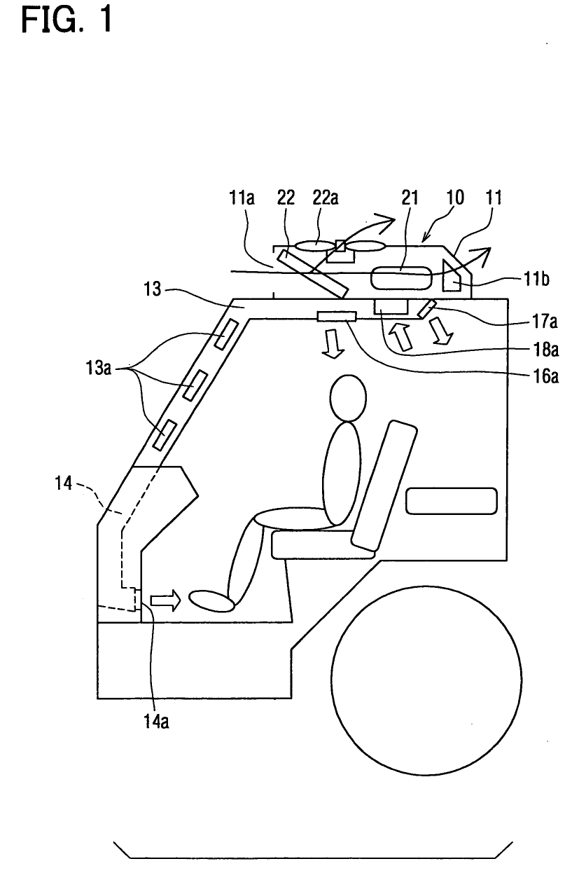

A first embodiment of the present invention will be explained with reference to FIGS. 1 to 6.

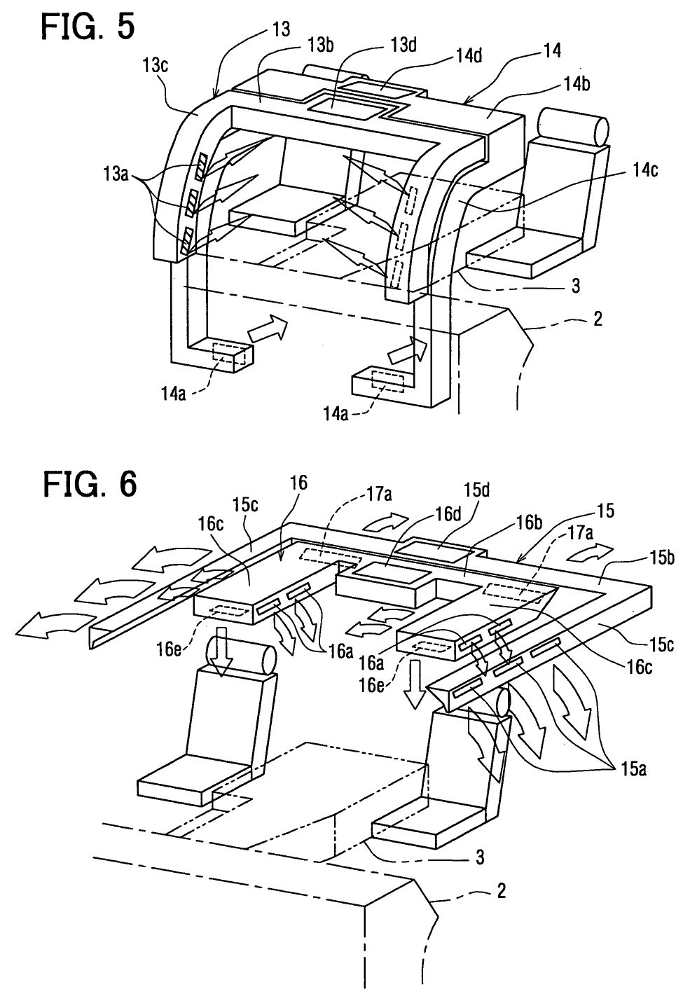

An air-conditioning system for a motor vehicle according to the first embodiment of the present invention comprises, as shown in FIG. 1, an air-conditioning unit 10 mounted on a roof of the motor vehicle, multiple blower openings 13a to 17a, 16e (FIGS. 5 and 6) for blowing out conditioned air into a passenger compartment in accordance with respective operational modes, multiple blower ducts 13 to 17 (FIGS. 5 and 6) for sending the conditioned air from the air-conditioning unit 10 to the respective blower openings 13a to 17a, and 16e, and an air suction opening 18a for sucking in the air from the passenger compartment.

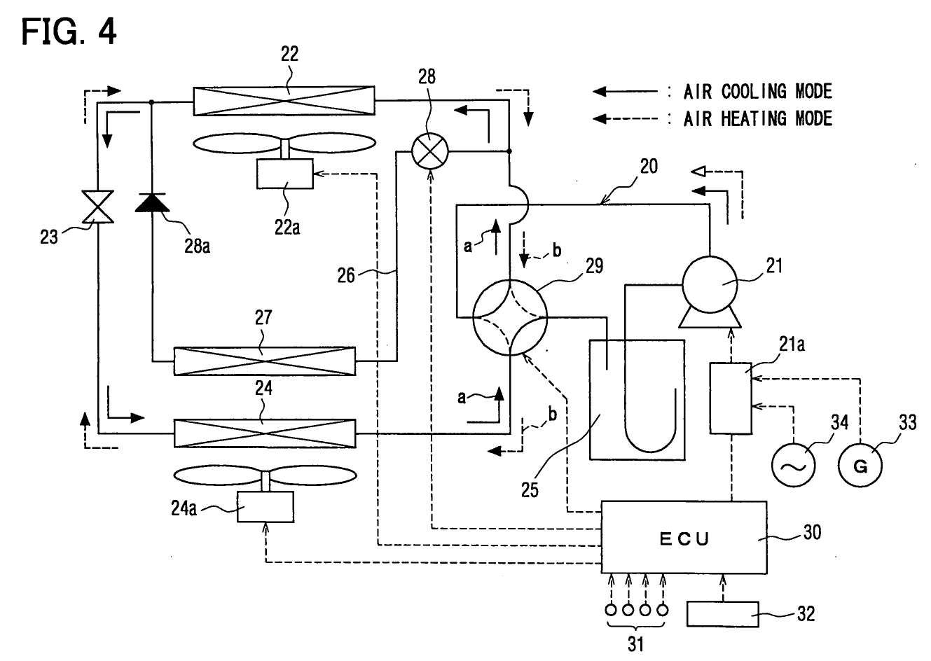

The air-conditioning unit 10 has a refrigerating cycle device 20 (FIG. 4) in its unit case 11, which comprises a compressor 21, a condenser 22 and so on. The unit case 11 is formed with duct openings 50 and 60, to which the multiple blower ducts 13 to 17 are connected by bifurcated connecting elements 40 (which will be explained later more in detail) and which are opened or closed in accordance with the respective operational modes. The air-conditioning unit 10 is, therefore, a unit for sucking the air from the passenger compartment through the air suction opening 18a and for sending the conditioned air into the respective blower ducts 13 to 17 through the duct openings 50 and 60.

The refrigerating cycle device 20 according to the embodiment is of a heat pump cycle, in which a flow direction of the refrigerant is changed over depending on a cooling and a heating operational modes. The device 20 comprises, as shown in FIG. 4, a refrigerating cycle, in which the compressor 21, the condenser 22, an expansion valve 23 (a depressurizing means) and an evaporator 24 are connected in a closed circuit. The device 20 further comprises a four way valve 29 and an accumulator 25, wherein the flour way valve 29 changes over a fluid flow so that the high pressure refrigerant compressed by the compressor 21 may flow into the condenser 22 during a cooling operation, while the refrigerant of high temperature flows into the evaporator 24 during a heating operation. And the low pressure refrigerant evaporated at the evaporator 24 during the cooling operation or at the condenser 22 during the heating operation flows back into the compressor 21.

The accumulator 25 is a device for sucking in the low pressure refrigerant evaporated at the evaporator 24 during the cooling operation or at the condenser 22 during the heating operation, and for supplying a gas phase refrigerant to the compressor 21 after dividing the sucked refrigerant into liquid phase and gas phase refrigerant. The accumulator 25 is provided between the four way valve 29 and an inlet side of the compressor 21. As a result, the refrigerant flows in a direction indicated by an arrow “a” of a solid line during the cooling operation, and flows in a direction indicated by an arrow “b” of a dotted line.

The compressor 21 in this embodiment is of an electrically operated compressor having an electric motor, which is selectively connected, though an inverter 21a, to an outside commercial power source through an electrical connecting device 34 or to a vehicle battery 33 which is charged with electric power generated by an electric power generating machine driven by an engine. For example, the compressor 21 (the electric motor) is operated by the electric power from the vehicle battery 33 during the motor vehicle is running, and operated by the electric power from the outside commercial power source (through the electrical connecting device 34) when the motor vehicle is stopped.

The inverter 21a is connected to an electronic control unit 30 to control a rotational speed of the electric motor connected to the compressor 21. When the inverter 21a is connected to the outside commercial power source 34 (through the electrical connecting device 34), it is connected to the power source via a power cord (not shown).

The condenser 22 condenses the high pressure refrigerant compressed by the compressor 21 during the cooling operation. The condenser 22 is assembled into the unit case 11 together with a condenser fan 22a, and the ambient air is taken into the unit case by the operation of the condenser fan 22a so that the heat in the refrigerant is radiated into the air to condense the refrigerant. The depressurizing means 23 is formed from capillary tubes to depressurize the refrigerant by expanding the same. The depressurized refrigerant flows into the evaporator 24.

The evaporator 24 is a heat exchanger for evaporating the refrigerant. The evaporator 24 is likewise assembled into the unit case 11 together with a blower fan 24a, so that the air is taken from the passenger compartment and cooled down by heat exchange at the evaporator 24. The conditioned (cooled down) air is then blown out to the passenger compartment through at least one of the blower openings (13a to 17a, 16e) . The refrigerant evaporated at the evaporator 24 flows back into the inlet side of the compressor 21.

In the refrigerating cycle device 20 of this embodiment, a bypass passage 26 is provided in parallel to the condenser 22, so that a part of the high pressure refrigerant compressed by the compressor 21 bypasses the condenser 22 during the cooling operation. In this bypass passage 26, an electromagnetic valve 28, a heat exchanger 27 and a check valve 28a are provided, wherein the heat exchanger 27 heats the air cooled down at the evaporator 24.

The electromagnetic valve 28 is connected to the electronic control unit 30 and controls an amount of the high pressure (high temperature) refrigerant flowing into the heat exchanger 27. The electromagnetic valve 28 is operatively opened upon a control signal from the control unit 30 during the cooling operation. The check valve 28a prevents the refrigerant condensed by the condenser 22 from flowing into the heat exchanger 27. The electrically operated components other than the inverter 21a, such as the four way valve 29, the condenser fan 22a, the blower fan 24a, the electromagnetic valve 28 and so on are also connected to and controlled by the electronic control unit 30.

The electronic control unit 30 comprises a computer for controlling the above mentioned electrically operated components, by computing in accordance with predetermined programs upon receiving detected signals from various kinds of sensors 31, such as an inside temperature sensor, an outside temperature sensor, an insolation sensor and so on, as well as operation signals from an operation panel 32. The electronic control unit 30 is likewise assembled into the unit case 11 together with the inverter 21a, battery 33, and the connecting device 34 to the outside commercial power source, as in the same manner to the refrigerating cycle device 20.

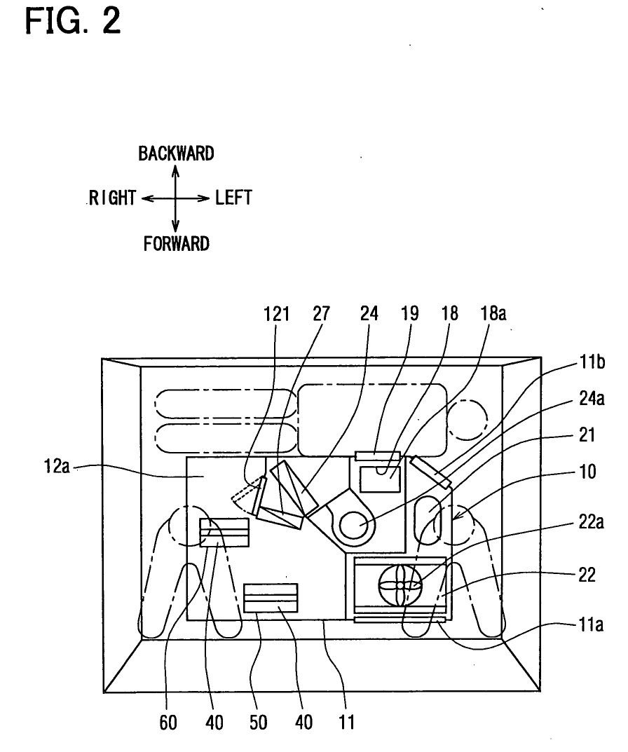

As shown in FIGS. 1 and 2, the compressor 21 is located at a left side of the motor vehicle in the unit case 11, and the condenser 22 and the condenser fan 22a are arranged at a forward side of the vehicle and in front of the compressor 21. The air is taken into the unit case 11 by the condenser fan 22a from a forward end opening 11a formed at a forward end of the unit case 11 and blown out to the outside through a grille 11b formed at a backward end of the unit case 11, wherein the air flows through the condenser 22 and a part of the air passes by the compressor 21.

The electric motor for driving the compressor 21 is thereby cooled down by the air passing by, which is a part of the air flowing through the condenser 22. When the vehicle is running, the air is also taken into the unit case from the forward end opening 11a due to ram-pressure. Although they are not shown in the drawing, the four way valve 29, the electromagnetic valve 28 and the accumulator 25 are arranged in the vicinity of the compressor 21. According to such arrangement of the components, a pipe arrangement for connecting those components with each other becomes simpler.

The blower fan 24a and the evaporator 24 are arranged in the vicinity of and at the right hand side of the compressor 21. An air suction aperture 18 is formed at the unit case 11 at an upstream side of the air flow generated by the blower fan 24a, wherein the aperture 18 is communicated with the passenger compartment through the air suction opening 18a formed at the ceiling of the passenger compartment. With this arrangement, the air is taken into the unit case 11 by the blower fan 24a from the passenger compartment and blown toward the evaporator 24. Although not shown in the drawing, the depressurizing means 23 is arranged in the vicinity of and at the upstream side of the evaporator 24.

In FIG. 2, a reference numeral 19 designates an outside air inlet opening formed at the unit case 11 and at a backward side of the suction aperture 18. A change-over door (not shown) is provided at the air suction aperture 18 and the outside air inlet opening 19, so that the inside air from the passenger compartment or the outside air is selectively taken into the unit case 11 by the blower fan 24a.

An air mix door 121 and the heat exchanger 27 are provided at a downstream side of the evaporator 24 to form an air mixing chamber 12a. The air mix door 121 controls the temperature of the air, by adjusting a mixing ratio of the air bypassing the heat exchanger 27 and the air passing through the heat exchanger 27. The cooled down air flowing out from the air mix door 121 and heated air passing through the heat exchanger 27 are mixed in the air mixing chamber 12a.

Multiple duct openings 50 and 60 (two openings in this embodiment) are formed at the unit case 11 opening to the air mixing chamber 12a. The bifurcated connecting elements 40 (described later) are provided at the duct openings 50 and 60.

Although not shown in the drawing, the electrical components, such as the inverter 21a, the battery 33, the connecting device 34, the electronic control unit 30 and so on are arranged at such positions in the air mixing chamber 12a, that those electrical components may not disturb the air flow in the chamber. The battery 33 can be arranged not in the air mixing chamber 12a (unit case 11) but in an engine compartment of the vehicle. In such an arrangement of the battery 33, a length of an electrical wire with a larger wire diameter connecting the electric power generating machine and the battery 33 can be made shorter, so that it is preferable to reduce the cost.

In FIG. 2, one-dot-chain lines show passengers in a driver's seat, in a side seat and in a nap-taking space. The conditioned air is blown out from the blower openings (foot blower openings 14a, faceblower openings 16a, veil blower openings 16e and nap-taking blower openings 17a) toward the passengers, as shown in FIGS. 1, 5 and 6. As described below, the blower openings are connected to the air mixing chamber 12a through multiple blower ducts 13 to 16.

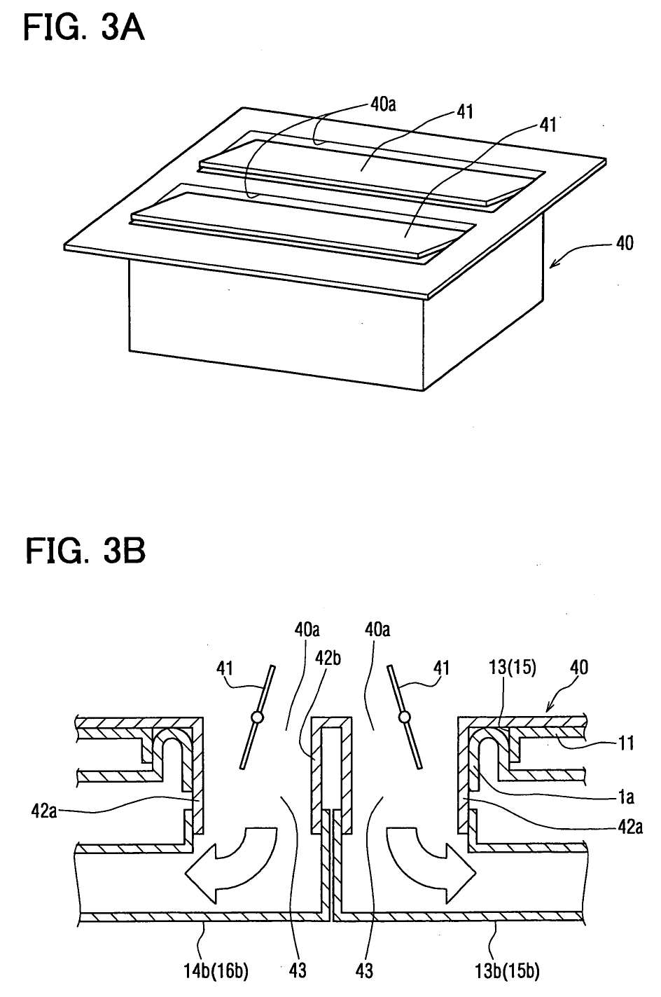

As shown in FIGS. 3A and 3B, each of the bifurcated connecting elements 40 provided to the duct openings 50 and 60 of the unit case 11 is formed with a pair of air sending openings 40a, a pair of control doors 41 pivotally supported at the air sending openings 40a, and a side wall 42a and a center wall 42b downwardly projecting out of lower ends of the unit case 11, so that bifurcated air passages are formed by the side wall 42a and the center wall 42b. The side wall and center wall portions 42a and 42b further project into a roof opening 1a formed at the vehicle roof, so that the respective air passages 43 formed by the side and center walls 42a and 42b are communicated to the blower ducts 13 and 14 (and 15 and 16). A sealing element (not shown) is provided between the bifurcated connecting elements 40 and the roof opening la to seal the passenger compartment from the outside of the vehicle.

In the case that multiple blower ducts 13 to 16 would be independently connected to the unit case 11 by means of connecting elements in a conventional manner, multiple duct openings corresponding to the number of the blower ducts would be necessary to be formed at the unit case 11, the same number of control doors should be provided to the respective duct openings, and furthermore the same number of the roof openings should be formed at the vehicle roof. The number of such roof openings would be at least 4 or 5 corresponding to the blower ducts 13 to 16.

According to the present invention, however, some of the blower ducts 13 to 16 are arranged to be in common use, the blower ducts 13 to 16 are divided into groups and the upstream sides of the blower ducts are put together in the respective groups, and the upstream sides of the respective groups are connected to the unit case 11 by the respective bifurcated connecting elements 40, to reduce the number of roof openings 1a to be formed at the vehicle roof. According to the present invention, the number of the roof openings can be reduced to a half number (two openings), compared with the number of the case in which the blower ducts are independently connected to the unit case.

The first bifurcated connecting element 40 provided to the duct opening 50, which is formed in the unit case 11 at a position of a forward side of the vehicle within the air mixing chamber 12a, is connected to the defroster blower duct 13 and the foot blower duct 14, which are respectively communicated at the other ends with the defroster blower openings 13a and the foot blower openings 14a, as best shown in FIGS. 2 and 5.

The second bifurcated connecting element 40 provided to the duct opening 60, which is formed in the unit case 11 at a position of a backward side of the vehicle within the air mixing chamber 12a, is connected to the side defroster blower duct 15 and the face blower duct 16, as best shown in FIGS. 2 and 6. The side defroster blower duct 15 is communicated at the other ends with the side defroster blower openings 15a. The face blower duct 16 is communicated with the face blower openings 16a, the veil blower openings 16e and the nap-taking blower openings 17a. In this embodiment, the blower duct for the face blower openings 16a and the blower duct for the nap-taking blower openings 17a are arranged in common use, namely the blower openings 16a and 17a are formed in the common blower duct (the face blower duct 16).

Actuators (not shown), such as servo motors, are provided to the control doors 41, to open or close the doors 41 for the air sending openings 40a in accordance with the various operational modes upon receiving control signals from the electronic control unit 30. The operational modes for the truck are a defrosting mode, a cooling mode, a heating mode, a dehumidifying and heating mode, and a nap-taking mode, and so on. At least one of the air sending openings 40a is controlled to open depending on the operational modes.

For example, the air sending opening 40a for the defroster blower duct 13 is opened in case of the defrosting mode, the other air sending opening 40a for the face blower duct 16 is opened in case of the cooling mode, the other air sending opening 40a for the foot blower duct 14 is opened in case of the heating mode, the air sending openings 40a for the defroster blower duct 13 and the side defroster blower duct 15 are opened in case of the dehumidifying and heating mode, the air sending opening 40a for the face blower duct 16 is further opened in case of the nap-taking mode. During the heating mode, the air sending openings 40a for the defroster blower duct 13 and the side defroster blower duct 15 can be also opened in addition to the air sending opening 40a for the foot blower duct 14, so that steamed up windshields may be cleaned.

The blower ducts which are provided inside the passenger compartment will be explained more in detail with reference to FIGS. 5 and 6. In FIG. 5, the defroster blower duct 13 and the foot blower duct 14 are shown, which are connected to the bifurcated connecting element 40 provided to the duct opening 50 of the unit case 11, while in FIG. 6, the side defroster blower duct 15 and the face blower duct 16 are shown, which are connected to the bifurcated connecting element 40 provided to the duct opening 60 of the unit case 11.

As shown in FIG. 5, the defroster blower duct 13 comprises a horizontally extending duct portion 13b and a pair of slantingly extending duct portions 13c connected to each end of the horizontally extending duct portion 13b, wherein the horizontally extending duct portion 13b is arranged at an inner surface of the vehicle roof (at a ceiling portion of the passenger compartment) while the slantingly extending duct portions 13c are arranged along left and right front pillar portions of the vehicle. An air inlet opening 13d, which is communicated with the air mixing chamber 12a through the bifurcated connecting element 40, is formed at a top surface of the horizontally extending duct portion 13b, and multiple defroster blower openings 13a are formed at side surfaces of the respective slantingly extending duct portions 13c, so that the conditioned air in the air mixing chamber 12a is blown out from the defroster blower openings 13a to the front windshield.

As is also shown in FIG. 5, the foot blower duct 14 likewise comprises a horizontally extending duct portion 14b and a pair of slantingly extending duct portions 14c connected to each end of the horizontally extending duct portion 14b, wherein the horizontally extending duct portion 14b is arranged at an inner surface of the vehicle roof (at the ceiling portion of the passenger compartment) while the slantingly extending duct portions 14c are arranged along left and right front pillar portions of the vehicle and further extend through an instrument panel portion 2 to a vicinity of passenger's feet. An air inlet opening 14d, which is communicated with the air mixing chamber 12a through the bifurcated connecting element 40, is formed at a top surface of the horizontally extending duct portion 14b, and the foot blower opening 14a is formed at a front end of the respective slantingly extending duct portions 14c, so that the conditioned air in the air mixing chamber 12a is blown out from the foot blower openings 14a toward the passenger's feet.

The air inlet openings 13d and 14d of the defroster blower duct 13 and the foot blower duct 14 are arranged to be laid side-by-side, and the side wall 42a and center wall 42b of the bifurcated connecting element 40 are inserted into the air inlet openings 13d and 14d, as already explained with reference to FIGS. 3A and 3B.

According to the above arrangement of the blower ducts, the conditioned air by the air-conditioning unit 10 can be respectively introduced into the blower ducts 13 and 14 to blow out the conditioned air from the defroster blower openings 13a and the foot blower openings 14a. The defroster blower duct 13 and the foot blower duct 14 are covered by interior parts from the upstream ends to the downstream ends.

In FIGS. 5 and 6, reference numeral 2 designates the instrument panel portion provided at a front side of the passenger compartment and reference numeral 3 designates a center console provided between two passenger seats.

As shown in FIG. 6, the side defroster blower duct 15 comprises a horizontally and laterally extending duct portion 15b and a pair of horizontally and longitudinally extending duct portions 15c connected to each end of the laterally extending duct portion 15b, wherein the laterally and longitudinally extending duct portions 15b and 15c are arranged at the inner surface of the vehicle roof (at the ceiling portion of the passenger compartment). An air inlet opening 15d, which is communicated with the air mixing chamber 12a through the bifurcated connecting element 40, is formed at a top surface of the laterally extending duct portion 15b, and multiple side defroster blower openings 15a are formed at side surfaces of the respective longitudinally extending duct portions 15c, so that the conditioned air in the air mixing chamber 12a is blown out from the side defroster blower openings 15a toward inner surfaces of the side windshields of the vehicle.

As is also shown in FIG. 6, the face blower duct 16 likewise comprises a horizontally and laterally extending duct portion 16b and a pair of horizontally and longitudinally extending duct portions 16c connected to each end of the laterally extending duct portion 16b, wherein the laterally and longitudinally extending duct portions 16b and 16c are arranged at the inner surface of the vehicle roof (at the ceiling portion of the passenger compartment). An air inlet opening 16d, which is communicated with the air mixing chamber 12a through the bifurcated connecting element 40, is formed at a top surface of the laterally extending duct portion 16b, and the multiple face blower openings 16a are formed at side surfaces of the respective longitudinally extending duct portions 16c, so that the conditioned air in the air mixing chamber 12a is blown out from the face blower openings 16a toward the passenger's upper body. The veil blower openings 16e are also formed at the longitudinally extending duct portions 16c, and the conditioned air is likewise blown out from the blower openings 16e toward the passenger's upper body, so that the air blown out from the blower openings 16a and 16e wraps around the upper body of the passenger from his head. The nap-taking blower openings 17a are further formed at a side surface of the laterally extending duct portion 16b to blow out the conditioned air from these blower openings 17a toward the passenger lying in the nap-taking space. As understood from FIG. 6 and the above description, the blower duct for the face blower openings and the blower duct for the nap-taking openings are arranged in common use in this embodiment.

The air inlet openings 15d and 16d of the side defroster blower duct 15 and the face blower duct 16 are arranged to be laid side-by-side, and the side wall 42a and center wall 42b of the bifurcated connecting element 40 are inserted into the air inlet openings 15d and 16d, as already explained with reference to FIGS. 3A and 3B.

Although not shown in the drawings, air control doors are respectively provided at the face blower openings 16a, the veil blower openings 16e and the nap-taking blower openings 17a, so that the air to be blown out from those blower openings can be respectively controlled and adjusted. Actuators may be provided to the air control doors, so that the air control doors may be controlled by the electronic control unit 30. The air control doors can be manually controlled by the passengers. The blower ducts 15 and 16 are likewise covered by interior parts, as the blower ducts 13 and 14.

The air-conditioning unit 10 and the blower ducts 13, 14, 15 and 16 are assembled to the vehicle in the following manner. The blower ducts 13 to 16 are at first assembled to the passenger compartment. The bifurcated connecting elements 40 are assembled to the respective duct openings 50 and 60 formed in the unit case 11. Then, the unit case 11, to which the refrigerating cycle device 20 are assembled, is mounted on the vehicle roof, wherein the side wall 42 and the center wall 43 of the bifurcated connecting elements 40 are inserted into the roof openings la formed in the vehicle roof and into the air inlet openings 13d, 14d, 15d and 16d of the respective blower ducts 13 to 16.

An operation of the above explained air-conditioning system will be explained.

When the air-conditioning system is operated in the cooling mode during running of the vehicle (the engine is running), a corresponding switch provided in a control panel 32 (FIG. 4) is switched on. Then, the four way valve 29 is switched to a position for the cooling mode and the compressor 21 with the electric motor is operated by the inverter 21a, which receives the control signal from the electronic control unit 30 and the electric power from the battery 33 charged with the electric power generated by the electric power generating machine driven by the engine.

The refrigerant is circulated in the refrigerating cycle by the operation of the compressor 21. The air is taken from the passenger compartment into the air-conditioning unit 10 by the operation of the blower fan 24a, and flows through the evaporator 24 to be cooled down. The air flows through the duct opening 60 into the face blower duct 16. The air cooled down is then blown out from the face blower openings 16a and the veil blower openings 16e toward the upper body of the passengers, wherein the air from the blower openings 16a and 16e wraps the upper body of the passengers. In this cooling mode, when any passenger is lying in the nap-taking space, the nap-taking openings 17a are manually or electronically opened to blow the cooled down air to the nap-taking space.

When the passenger compartment is to be kept cool even during the vehicle (truck) is stopped (the engine operation is also stopped) for loading the baggage onto and/or pulling down the baggage from the truck, the corresponding switch of the control panel 32 is switched on, so that the above mentioned operation for the cooling mode is continued.

When the electrical connecting device 34 (FIG. 4) is connected to the outside commercial electric power source, during the vehicle is stopped, the electronic control unit 30 switches from the battery 33 to the outside commercial power source, so that the electric power is supplied to the electric motor of the compressor 21 from the outside commercial electric power source.

When a driver will take a nap in the nap-taking space by parking the truck, the compressor 21 is continuously operated in the same manner as above so that the cooled down air is blown out from the nap-taking blower openings 17a into the nap-taking space. In this operation, face blower openings 16a and the veil blower openings 16e may be manually closed or electronically closed by the control unit 30.

The dehumidifying and heating mode will be explained. When the outside temperature is rather low but humidity (in the passenger compartment) is high, the corresponding switch of the control panel 32 is switched on, so that the electromagnetic valve 28 (FIG. 4) is opened by the control signal from the electronic control unit 30. Then a part of the compressed refrigerant of high pressure and high temperature is allowed to flow into the heat exchanger 27. The air passing through the evaporator 24 is dehumidified in a process of cooling the air down, and the cooled down air is heated by the heat exchanger 27. Such dehumidified and heated air flows through the duct opening 50 into the defroster blower duct 13 and the side defroster blower duct 15, and is finally blown out from the defroster blower openings 13a and the side defroster blower openings 15a, to remove the clouding on the windshields.

When the heating mode is performed, the corresponding switch of the control panel 32 is likewise switched on. The four way valve 29 is switched to a position for the heating mode and the compressor 21 starts to operate, so that the compressed refrigerant of high temperature flows into the evaporator 24. The blower fan 24a is also operated, so that the air passing through the evaporator 24 is heated and flows through the duct opening 50 into the foot blower duct 14, and the heated air is blown out from the foot blower openings 14a toward the passenger's feet to heat the passenger compartment.

In this operational mode, when the control door 41 for the defroster blower duct 13 and/or the side defroster blower duct 15 are opened, a part of the heated air flows into the respective blower ducts and blown out from the blower openings 13a and/or 15a to remove the clouding on the windshields.

When the defrosting mode is performed, the corresponding switch of the control panel 32 is likewise switched on. Then the flour way valve 29 is switched to the position for this operational mode by the control signal from the electronic control unit 30, and the compressor 21 starts its operation so that the compressed refrigerant of high temperature flows into the evaporator 24. The air flow is generated by the operation of the blower fan 24a, and the air passing through the evaporator 24 is heated and flows through the duct opening 50 into the defroster blower duct 13, and the heated air is blown out from the defroster blower openings 13a toward the front windshield to remove the clouding on the windshield.

As explained above, if the blower ducts were provided for the respective operational modes, a relatively large number of blower ducts would become necessary. And furthermore, if such large number of the blower ducts were independently and separately connected the air-conditioning unit, the same (large) number of the duct openings (four or five duct openings) would also become necessary at the air-conditioning unit. Furthermore, the same number of roof openings would be necessary at the vehicle roof, in order that the respective blower ducts could be independently connected to the air-conditioning unit through such roof openings.

According to the present invention, however, some of the blower ducts are arranged to be in common use, the multiple blower ducts are divided into a smaller number of groups and the air inlet openings of the blower ducts are collected at one place in the respective groups so that the air inlet openings are connected to an air-conditioning unit at such collected places. As a result, the number of duct openings to be formed at the unit case as well as the number of roof openings to be formed at the vehicle roof can be reduced to two in the above first embodiment.

Furthermore, the respective blower openings can be arranged at such positions, which are most appropriate for the respective operational modes, so that most comfortable air-conditioning operation can be achieved.

In case of the air-conditioning system for the trucks, as explained above, five different blower ducts are generally necessary, namely those are the defroster blower duct, the foot blower duct, the side defroster blower duct, the face blower duct and the nap-taking blower duct. In the above explained first embodiment, however, the face blower duct and the nap-taking blower duct are made into one blower duct by arranging the blower duct at an appropriate position so that the blower duct can be in common use for the face blower duct and the nap-taking blower duct. As a consequence, according to the first embodiment, the number of connecting portions between the multiple blower ducts and the unit case can be reduced by one.

According to the first embodiment, the defroster blower duct 13 as well as the foot blower duct 14, respectively, comprises the horizontally extending duct portions 13b and 14b arranged at the inner surface of the vehicle roof and the pairs of the slantingly extending duct portions 13c and 14c along with the left and right front pillars of the vehicle. And therefore, the front vision of the passengers may not be narrowed. Furthermore, as the defroster blower openings 13a and the foot blower openings 14a are arranged at the appropriate positions, the comfortable air-conditioning operation can be achieved.

The bifurcated connecting elements 40, in which at least two air passages are formed at its downstream side, are provided to the duct openings 50 and 60 of the unit case 11, and the opening and closing of the air sending openings 40a of the bifurcated connecting elements 40 are controlled by the respective control doors 41 in accordance with the respective operational modes. As a consequence, the number of the roof openings 1a to be formed at the vehicle roof can be reduced from four to two, in the first embodiment.

In the air-conditioning unit 10 of the above first embodiment, those components for the refrigerating cycle device 20, such as the evaporator 24, the electrically driven compressor 21 which is operated by either the battery 33 or the outside commercial power source, the condenser 22 and the depressurizing means 23 are integrally formed. Accordingly, even when the engine for the vehicle is stopped, the air-conditioning operation can be continuously carried on by driving the electrically driven compressor 21 with the electric power from the battery 33 or from the outside commercial power source. It is, particularly, preferable for such vehicles (trucks), in which the engine operation is automatically stopped under the recent emission control regulation, when a time period of the engine idling operation exceeds a certain value due to a traffic jam, a red traffic lamp, the loading the baggage into the truck or pulling down the baggage from the truck.

Furthermore, all of the components for the refrigerating cycle device 20, including the electrically driven compressor 21, are integrally assembled into the air-conditioning unit 10, as explained above in the first embodiment, and the air-conditioning unit 10 is mounted on the vehicle roof. Accordingly, any pipe connection for the refrigerating cycle is not necessary between the engine compartment and the air-conditioning unit 10, so that the air-conditioning unit 10 can be easily mounted on the vehicle roof and at the same time the number of parts for the air-conditioning unit can be reduced.

The refrigerating cycle device 20 comprises the heat pump cycle, in which the flow direction of the refrigerant is changed depending on the cooling mode and the heating mode. And the compressed refrigerant of the high temperature is arranged to flow from the compressor 21 into the evaporator 24 during the heating mode. In a conventional air-conditioning system, on the other hand, a heater core is provided for the heating mode, in which an engine cooling water is circulated through the engine and the heater core. Accordingly, in such conventional system, a pipe connection is inevitably necessary between the engine and the heater core. According to the present invention, however, as the heat pump cycle is used for the air-conditioning unit 10, such a pipe connection is not necessary. As a result, also from this point of view, the air-conditioning unit can be easily mounted on the vehicle roof and the number of parts for the air-conditioning unit can be reduced.

Furthermore, according to the above first embodiment, a part of the compressed refrigerant of the high temperature is arranged to flow from the compressor 21 into the heat exchanger 27. And therefore, even when the dehumidifying and heating operation is necessary at the same time in the case that the outside temperature is rather low and the humidity in the passenger compartment is high, such dehumidifying and heating operation can be done by making use of the part of the compressed refrigerant. As above, the function of dehumidifying and heating operation can be easily added to the air-conditioning system.

In the above first embodiment, the multiple blower ducts are covered by the interior parts, so that the comfortable interior can be obtained.

The nap-taking space is generally provided behind the driver seat in the truck. As the nap-taking blower openings are provided in the above first embodiment, a more comfortable air-conditioning operation can be provided to the passengers, even when the vehicle (truck) and the engine is stopped.

### Second Embodiment

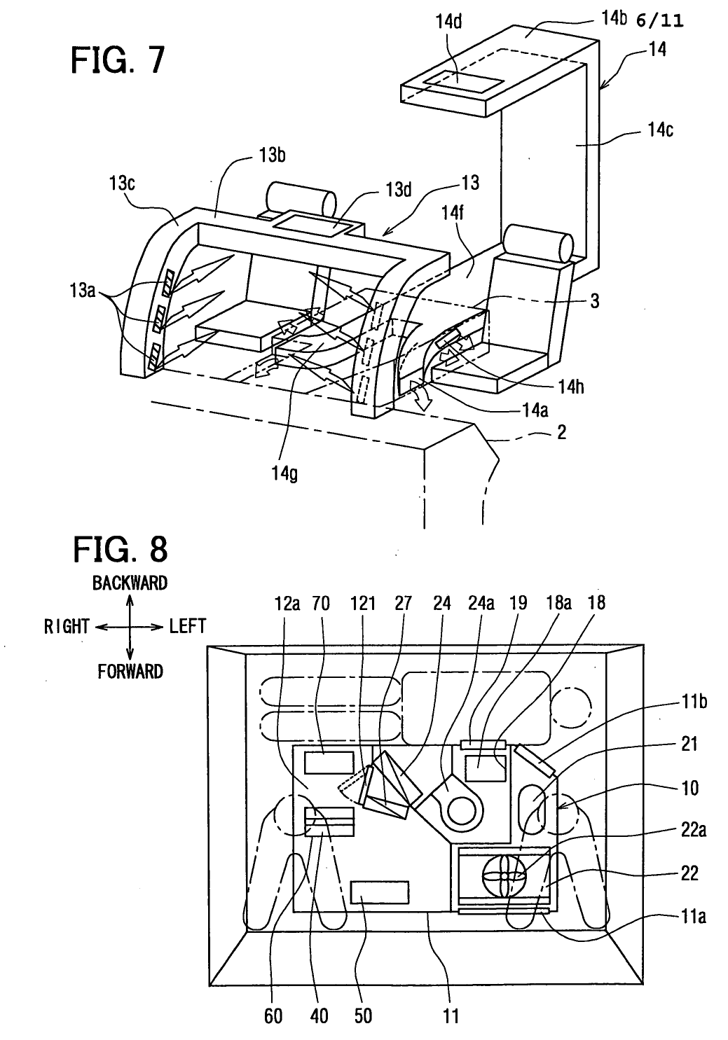

A second embodiment of the present invention will be explained with reference to FIGS. 7 and 8, which differs from the first embodiment in the structure of the foot blower duct 14.

As shown in FIG. 7, the foot blower duct 14 comprises a horizontally and longitudinally extending duct portion 14b (a first duct portion) arranged at an inner surface of the vehicle roof, a vertically extending duct portion 14c (a second duct portion) provided at a backward side of a passenger compartment and communicated at its one end with the first duct portion 14e, a horizontally and longitudinally extending duct portion 14f (a third duct portion) provided at a floor beneath a center console 3 and communicated at its one end with the other end of the second duct portion 14c, and a pair of forked duct portions 14g (a fourth duct portion) extending from the other end of the third duct portion 14f toward the front side of the passenger compartment and terminating at the vicinity of the passenger's feet. According to the second embodiment, since the foot blower duct 14 (in particular, the second duct portion 14c) is arranged at the backward side of the passenger compartment, the vision of the passenger around the front pillars can be further improved when compared with the first embodiment.

According to the second embodiment, however, an air inlet opening 14d can not be arranged close to the air inlet opening 13d like the first embodiment, because the side defroster blower duct 15 and the face blower duct 16 are existing between the defroster blower duct 13 and the foot blower duct 14. As a result, another duct opening 70 is formed in the unit case 11 opening to the air mixing chamber 12a, as shown in FIG. 8.

The duct openings 50 and 70 of the unit case 11 are connected to the air inlet openings 13d and 14d of the blower ducts 13 and 14 through connecting elements (not shown). The connecting elements are similar to that in FIG. 3A but not bifurcated. And a control door (not shown) and an actuator (not shown) are also provided at air sending openings of the connecting elements, like in the first embodiment (FIG. 3A), for opening or closing the air sending openings upon receiving a control signal from the electronic control unit 30.

According to the second embodiment, although the number of the roof openings to be formed at the vehicle roof becomes 3, the second embodiment is still smaller in number of the roof openings than the conventional system (in which at least four roof openings are necessary). A reference numeral 14h in FIG. 7 designates seat blower openings for blowing the conditioned air toward a waist and lower body of the passenger. The seat blower openings 14h are provided in the blower duct 14 at an upstream side of the foot blower openings 14a.

### Third Embodiment

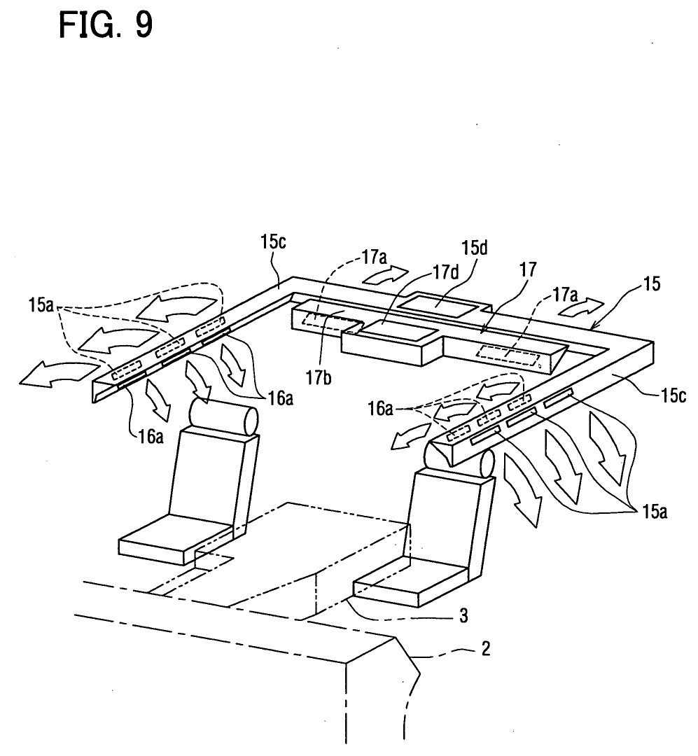

In the first embodiment, the face blower openings 16a are formed in the horizontally and longitudinally extending duct portions 16c and the nap-taking blower openings 17a are formed in the horizontally and laterally extending duct portion 16b, as shown in FIG. 6. In the third embodiment, shown in FIG. 9, however, a nap-taking blower duct 17 is provided in the place of the face blower duct 16 of the first embodiment (FIG. 6) and the nap-taking blower openings 17a are formed in the nap-taking blower duct 17. The face blower openings 16a are formed in the horizontally and longitudinally extending duct portions 15c, wherein the side defroster blower openings 15a are formed, as in the same manner to the first embodiment (FIG. 6), directing toward the side windshields of the vehicle, while the face blower openings 16a are directed toward the upper body of the passengers.

As in the same manner to the first embodiment, the air inlet opening 15d of the side defroster blower duct 15 is connected to the unit case 11 through the bifurcated connecting element, and the control doors 41 are provided at the air sending openings of the bifurcated connecting element 40 for opening or closing the side defroster blower duct 15. The opening and closing of the blower duct 15 can be controlled by the actuators provided at the control doors 41 upon receiving the control signals from the control unit 30, or the control doors 41 can be manually operated.

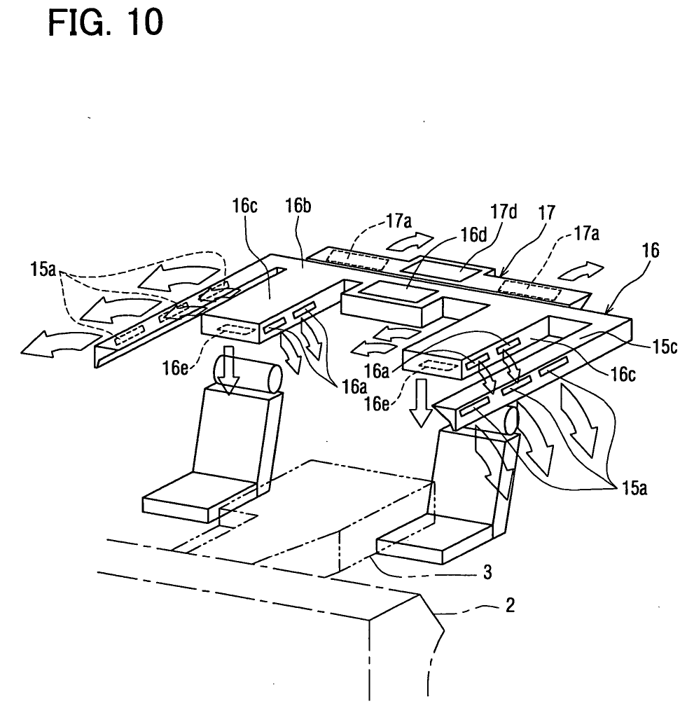

In the above third embodiment, the face blower openings 16a and the side defroster blower openings 15a are formed in the same blower duct 15. The blower openings 16a and 15a can be further arranged in a modification shown in FIG. 10. This modification of FIG. 10 differs from the first embodiment (FIG. 6) in the structures of the face blower duct 16 and the side defroster blower duct 15. The face blower duct 16 comprises the horizontally and laterally extending duct portion 16b and the pair of horizontally and longitudinally extending duct portions 16c (the first forked duct portions longitudinally extending above the passengers' heads), as in the first embodiment, wherein the face blower duct 16 further comprises another pair of horizontally and longitudinally extending duct portions 15c (the second forked duct portions), which extend longitudinally above the side windshields. And the face blower openings 16a and the veil blower openings 16e are formed in the first forked duct portions 16c, whereas the side defroster openings 15a are formed in the second forked duct portions 15c.

The nap-taking blower duct 17 is provided close to the face blower duct 16 and the air inlet portions 16d and 17d of the ducts 16 and 17 are arranged to be close to each other.

### Fourth Embodiment

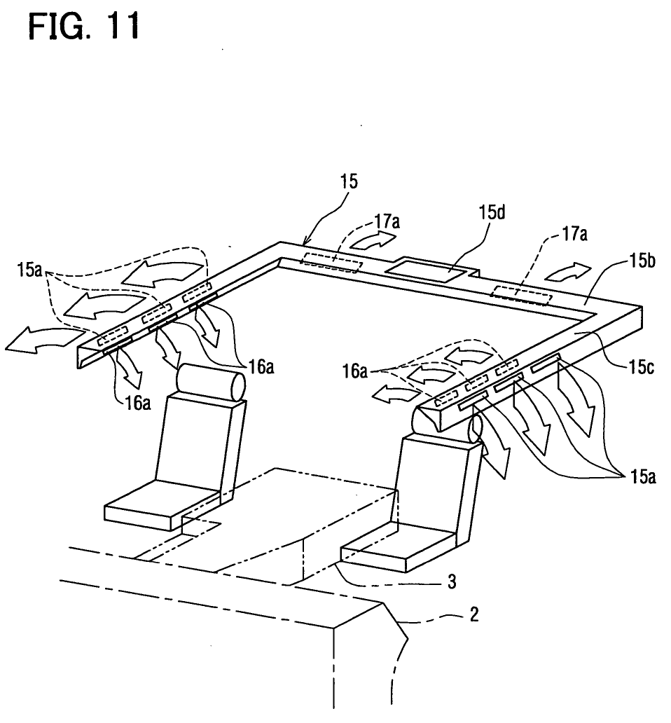

In the fourth embodiment, as shown in FIG. 11, the face blower duct 16, the side blower duct 15 and the nap-taking blower duct 17 are arranged to be in common use. Furthermore, when compared with the third embodiment shown in FIG. 9, the nap-taking blower duct 17 is taken out and the nap-taking blower openings 17a are instead formed in the side defroster blower duct 15. As in the same manner to the third embodiment of FIG. 9, the face blower openings 16a and the side defroster openings 15a are formed in the pair of horizontally and longitudinally extending duct portions 15c.

The air inlet opening 15d of the side defroster blower duct 15 is connected to the unit case 11 through a connecting element (not shown) and a control door is provided at air sending opening of the connecting element, as in a similar manner shown in FIG. 3A. The opening and closing of the blower duct 15 can be controlled by an actuator provided at the control door upon receiving the control signals from the control unit 30, or the control door can be manually operated.

According to the fourth embodiment, the number of blower ducts can be reduced to three, compared with the first and/or third embodiment.

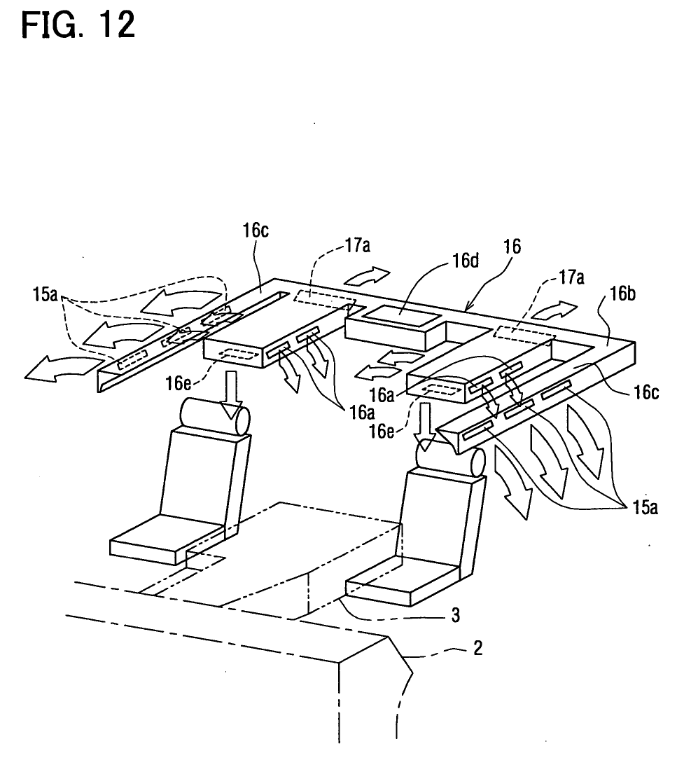

The face blower duct 16 of FIG. 10 can be further modified in a manner shown in FIG. 12, which differs from the third embodiment shown in FIG. 10, in that the nap-taking blower duct 17 is taken out and instead the nap-taking blower openings 17a are formed in the face blower duct 16. According to this modification, the number of blower ducts can be also reduced to three.

### Other Embodiment

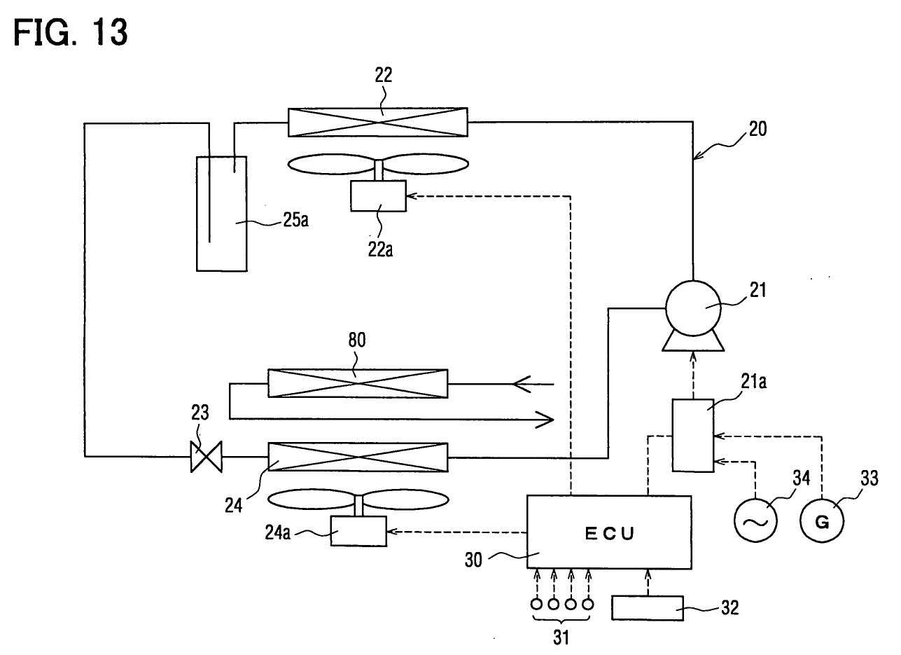

In the above mentioned embodiments, the refrigerating cycle device 20 comprises the heat pump cycle, in which the flow direction of the refrigerant is changed over depending on the cooling mode and the heating mode. It is, however, that the present invention is not limited to the refrigerating cycle device 20 having the heat pump cycle. Namely, as shown in FIG. 13, the refrigerating cycle 20 comprises a normal refrigerating cycle according to which the cooling operation alone can be performed. And a heater core 80, which is connected to an engine (not shown) and through which engine cooling water is circulated, is provided at a downstream side of the evaporator 24, so that the air cooled down at the evaporator 24 can be heated at the heater core 50.

In this refrigerating cycle, a receiver 25a is provided between the condenser 22 and the depressurizing means 23 (expansion valve). According to this modification, although it is not possible to continue the heating operation for a long period after the engine is stopped, the heating operation can be continued for a certain period after the engine stall.

In the above mentioned embodiments, all of the components for the refrigerating cycle device 20 are assembled into the air-conditioning unit 10. However, the compressor 21, the condenser 22 and the condenser fan 22a can be arranged in the engine compartment. The compressor 21 is not always the electrically driven compressor but such a well known compressor which is driven by the engine.

1. An air-conditioning system for a motor vehicle comprising:
an air-conditioning unit to be mounted on a roof of the motor vehicle;
multiple duct openings formed in a unit case of the air-conditioning unit;
an evaporator provided in the unit case for cooling air flowing through the evaporator;
a heat exchanger provided in the unit case at a downstream side of the evaporator for heating the air passing through the evaporator, so that the air, the temperature of which is controlled by the evaporator and the heat exchanger, is sent into a passenger compartment of the motor vehicle through at least one of the duct openings depending on respective operational modes;
multiple blower ducts, each having an air inlet opening at its upstream end to be respectively connected to the duct openings and a blower opening at its downstream end; and
multiple connecting elements for connecting the duct openings with the air inlet openings of the blower ducts, so that multiple air passages formed by the duct openings, the connecting elements and the air inlet openings pass through multiple roof openings formed at the roof of the motor vehicle,
wherein the air inlet openings of at least two blower ducts are arranged close to each other,
the connecting element for such two blower ducts has a bifurcated air passage portions respectively connected to the air inlet openings, and
each of the blower ducts has a horizontally extending duct portion arranged at a ceiling portion of the passenger compartment of the motor vehicle.

2. An air-conditioning system according to claim 1, wherein
the multiple blower ducts comprise at least two of the following ducts;
a defroster blower duct having a defroster blower opening for blowing the conditioned air toward an inner surface of a front windshield of the motor vehicle;
a foot blower duct having a foot blower opening for blowing the conditioned air toward passenger's feet;
a side defroster blower duct having a side defroster blower opening for blowing the conditioned air toward an inner surface of a side windshield of the motor vehicle;
a face blower duct having a face blower opening for blowing the conditioned air toward an upper body of the passenger; and
a nap-taking blower duct having a nap-taking blower opening for blowing the conditioned air toward a nap-taking space located behind passenger seats.

3. An air-conditioning system according to claim 2, wherein the multiple blower ducts comprise;
a defroster blower duct having a defroster blower opening for blowing the conditioned air toward an inner surface of a front windshield of the motor vehicle;
a foot blower duct having a foot blower opening for blowing the conditioned air toward passenger's feet;
a side defroster blower duct having a side defroster blower opening for blowing the conditioned air toward an inner surface of a side windshield of the motor vehicle; and
a face blower duct having a face blower opening for blowing the conditioned air toward an upper body of the passenger.

4. An air-conditioning system according to claim 3, wherein
the multiple blower ducts further comprise;
a nap-taking blower duct having a nap-taking blower opening for blowing the conditioned air toward a nap-taking space located behind passenger seats.

5. An air-conditioning system according to claim 2, wherein
the face blower duct and the nap-taking blower duct are arranged to be in common use, so that the face blower opening and the nap-taking blower opening are formed in the common blower duct.

6. An air-conditioning system according to claim 2, wherein
the face blower duct and the side defroster blower duct are arranged to be in common use, so that the face blower opening and the side defroster blower opening are formed in the common blower duct.

7. An air-conditioning system according to claim 2, wherein
the face blower duct, the side defroster blower duct and the nap-taking blower duct are arranged to be in common use, so that the face blower opening, the side defroster blower opening and the nap-taking blower opening are formed in the common blower duct.

8. An air-conditioning system according to claim 2, wherein
the defroster blower duct comprises:
a horizontally and laterally extending duct portion provided at the ceiling portion of the passenger compartment; and
a slantingly extending duct portion provided along a pillar of the motor vehicle,
wherein the defroster blower opening is formed at the slantingly extending duct portion for blowing the conditioned air toward the inner surface of the front windshield.

9. An air-conditioning system according to claim 2, wherein
the foot blower duct comprises:
a horizontally and laterally extending duct portion provided at the ceiling portion of the passenger compartment; and
a slantingly extending duct portion provided along a pillar of the motor vehicle and terminating at a vicinity of passenger's feet,
wherein the foot blower opening is formed at the slantingly extending duct portion for blowing the conditioned air toward the passenger's feet.

10. An air-conditioning system according to claim 2, wherein
the foot blower duct comprises:
a horizontally and longitudinally extending duct portion provided at the ceiling portion of the passenger compartment;
a vertically extending duct portion provided at a backward side of the passenger compartment; and
a horizontally and longitudinally extending duct portion provided at a floor beneath a center console,
wherein the foot blower opening and a seat blower opening are formed at the latter horizontally longitudinally extending duct portion for blowing the conditioned air toward the passenger's feet and a lower body of the passenger.

11. An air-conditioning system according to claim 1, wherein
the connecting element having bifurcated air passages comprises:
a pair of air sending openings opening to an air mixing chamber of the air-conditioning unit; and
a pair control valves respectively provided at the air sending openings for opening and closing the air sending openings depending on the respective operational modes.

12. An air-conditioning system according to claim 1, wherein
the air-conditioning unit comprises:
a battery to be charged with electric power generated at an electric power generating machine driven by an engine of the motor vehicle;
an electrical connecting device to be connected to an outside commercial power source;
an electrically driven compressor operated by the electric power supplied from one of the battery and the electrical connecting device;
a condenser; and
a depressurizing means,
wherein all of the above components are assembled into the unit case of the air-conditioning unit.

13. An air-conditioning system according to claim 12, wherein,
the air-conditioning unit comprises a heat pump cycle, in which fluid flow of the refrigerant is changed over depending on a cooling mode and a heating mode of the air-conditioning system, and
the compressed refrigerant of high pressure and high temperature flows from the compressor into the evaporator during the heating mode.

14. An air-conditioning system according to claim 12, wherein,
a part of the compressed refrigerant of high pressure and high temperature flows from the compressor into the heat exchanger.

15. An air-conditioning system according to claim 1, wherein,
the motor vehicle to which the air-conditioning system is mounted is a truck, and
the multiple blower ducts are provided at an inner wall of the passenger compartment and covered by interior parts from the air inlet openings to the blower openings.
